(19) United States
(12) Patent Application Publication
(10) Pub. No.: US 2004/0251355 A1
(43) Pub. Date: Dec. 16, 2004

(54) Bale opening apparatus

(76) Inventor: Maqbool Elahi Raja, Simpsonville, SC (US)

Correspondence Address: Adams Evans P.A., 2180 Two Wachovia Center, Charlotte, NC, 28282, US

(21) Appl. No.: 10/459,779

(22) Filed: Jun. 12, 2003

(51) Int. Cl. B02C 19/12

(52) U.S. Cl. 241/186.35; 241/605

(57) ABSTRACT

An inclined conveyor for supporting and feeding a longitudinally-extending array of bales, and a beater assembly positioned at a downstream end of the conveyor for receiving the downstream end of a downstream-most bale being moved by the conveyor. The beater assembly includes a plurality of beaters laterally mounted on respective shafts across a width of the conveyor for plucking tufts of fibers from the bale being fed by the conveyor, a beater enclosure within which the beaters are enclosed, and a drive enclosure positioned laterally to a drive side of the beater enclosure. The drive enclosure includes motor assemblies for driving the beaters by rotation of the respective shafts, and an access enclosure positioned laterally to an access side of the beater enclosure for allowing access to the beaters for removal and replacement of the beaters laterally from the second side of the beater enclosure.

### TECHNICAL FIELD AND BACKGROUND OF THE INVENTION

This invention relates to a bale opening apparatus of the type wherein bales of staple fiber are moved progressively into engagement with rotating drums, called “beaters”, that covered with outwardly-projecting teeth that pull tufts of staple fiber from the bale. Typical of such machines is the Fiber Controls Corporation “Snowbreaker” bale opening apparatus that has been sold for many years. This invention improves on this bale opening apparatus by providing for easier access to the drums for inspection, repair and replacement by providing access to the drums from the side of the apparatus rather than the front. In addition, safety and operational improvements are provided.

### SUMMARY OF THE INVENTION

Therefore, it is an object of the invention to provide a bale opening apparatus that provides for easier access to the opening drums.

It is another object of the invention to provide a bale opening apparatus that provides enhanced safety.

It is another object of the invention to provide a bale opening apparatus that provides enhanced operation of the beaters.

These and other objects of the present invention are achieved in the preferred embodiments disclosed below by providing a bale opening apparatus, comprising an inclined conveyor for supporting and feeding a longitudinally-extending array of bales, and a beater assembly positioned at a downstream end of the conveyor for receiving the downstream end of a downstream-most bale being moved by the conveyor. The beater assembly includes a plurality of beaters laterally mounted on respective shafts across a width of the conveyor for plucking fibers from the bale being fed by the conveyor, a beater enclosure within which the beaters are enclosed, a drive enclosure positioned laterally to a drive side of the beater enclosure, the drive enclosure including motor assemblies for driving the beaters by rotation of the respective shafts, and an access enclosure positioned laterally to an access side of the beater enclosure for allowing access to the beaters for removal and replacement of the beaters laterally from the access side of the beater enclosure.

According to one preferred embodiment of the invention, the beater assembly includes bearing blocks within which the shafts are mounted for rotation.

According to another preferred embodiment of the invention, the access enclosure includes at least one access plate for covering the beaters during operation and removable for gaining access to the beaters.

According to yet another preferred embodiment of the invention, the access enclosure includes a plurality of access plates for covering respective ones of the beaters during operation and selectively removable for gaining access to respective ones of the beaters.

According to yet another preferred embodiment of the invention, the access enclosure includes a plurality of access plates for covering respective ones of the beaters during operation and selectively removable for gaining access to respective ones of the beaters and further wherein the beater assembly further includes an apron roll and an apron roll access plate for covering the apron roll during operation and selectively removable for gaining access to the apron roll.

According to yet another preferred embodiment of the invention, the drive enclosure includes a protective cover for enclosing the drive enclosure and an interlock safety switch for preventing the removal of the protective cover during operation of the beaters.

According to yet another preferred embodiment of the invention, each beater is provided with an individual motor assembly.

According to yet another preferred embodiment of the invention, each motor assembly is mounted in the drive enclosure.

According to yet another preferred embodiment of the invention, each of the beaters is dynamically balanced.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a overall perspective view of the Bale opener according to an embodiment of the invention;

FIG. 2 is a side elevation view of the drive side of the beater housing of the Bale opener with parts broken away;

FIG. 3 is a side elevation view of the access side of the beater housing of the Bale opener with parts broken away; and

FIG. 4 is a front elevation of the beater housing.

### DESCRIPTION OF THE PREFERRED EMBODIMENT AND BEST MODE

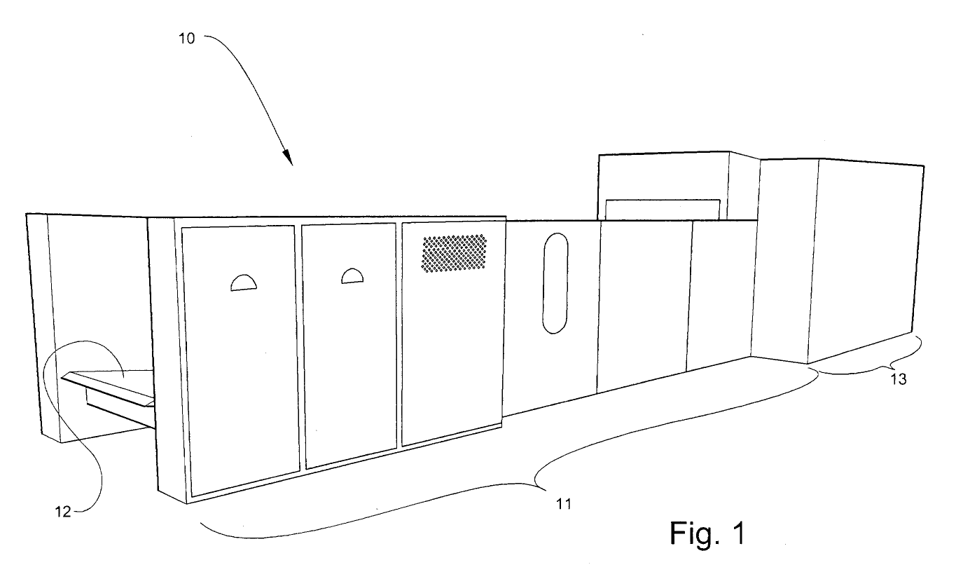

Referring now specifically to the drawings, a Bale opener according to the present invention is illustrated in FIG. 1 and shown generally at reference numeral 10. The beater 10 includes an elongate conveyor housing 11 carrying a conveyor 12 and into which bales of staple fiber are fed. The bales are moved by the conveyor 12 along the length of the conveyor housing 11 to a beater housing 13, where the bales are disintegrated and moved downstream for further processing. The conveyor housing 11 and components are conventional and not further described herein.

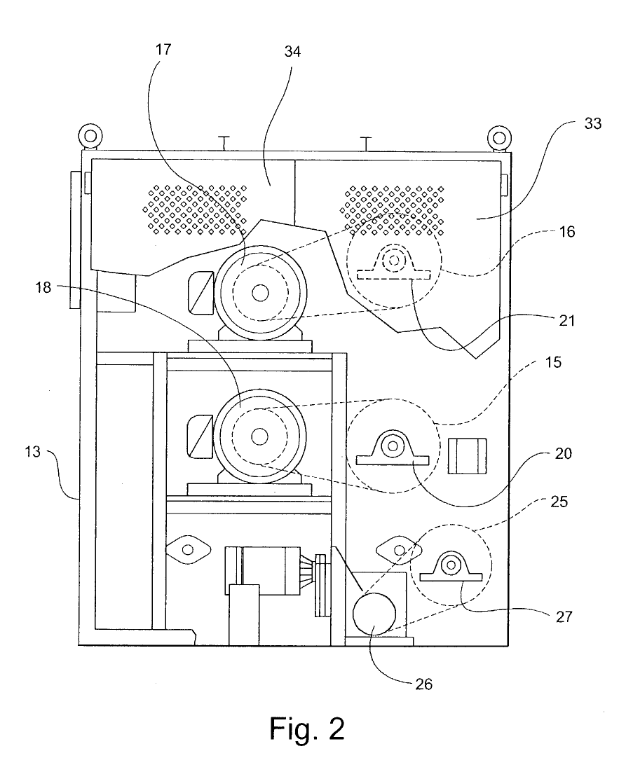

Referring now to FIGS. 2, 3 and 4, the beater housing 13 sits at the downstream end of the beater and includes first and second elongate cylindrical beaters 15 and 16 driven by respective inverter duty electric motors 17 and 18. The beaters 15, 16 are clothed with angled teeth mounted in spiral arrays that tear off tufts of fiber as the bales are fed into the beater section 13.

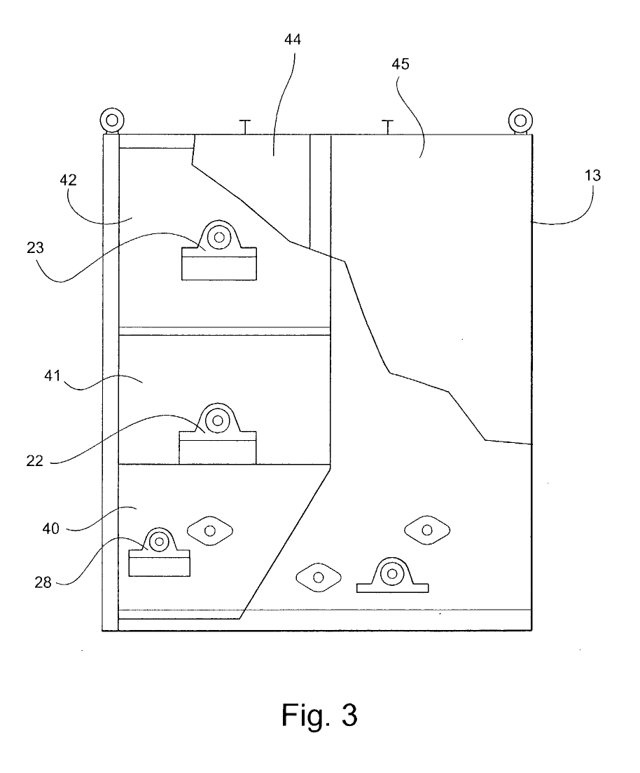

The beaters 15 and 16 are mounted in pillow block bearings 20, 21, 22, 23, see FIG. 3. The beaters 15 and 16 are dynamically balanced to G1 specifications and are adjustable. Beaters 15 and 16 are both vertically and horizontally adjustable. Vertical adjustment is accomplished by inserting or removing flat metal shims from beneath the pillow block bearings 20, 21, 22, and 23. Adjustment is in the range of ½ to ⅞ inches. Horizontal adjustment is accomplished by adjustment rods in a conventional manner. The beaters 15 and 16 each have a 24 inch outside diameter with a 2 & 3/16 inch shaft.

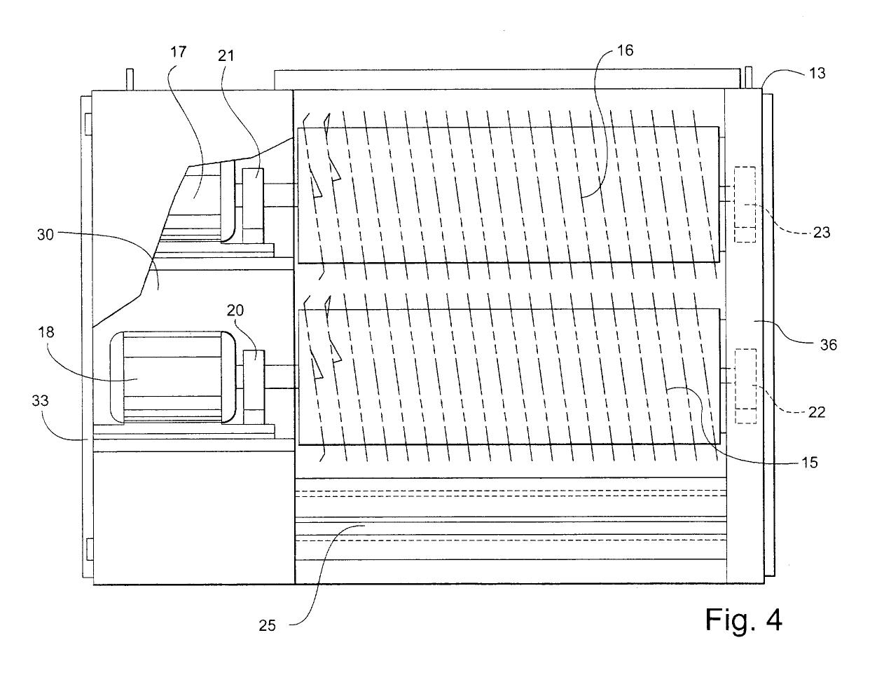

A flat apron sprocket 25 mounts a flat apron conveyor, not shown, onto which the fiber drops and is carried downstream. The sprocket 25 is driven by a drive motor 26. The sprocket 25 is mounted on pillow block bearings 27, 28. As is best shown by reference to FIGS. 2 and 4, the motors 17, 18 and 27 are mounted inside a cabinet 29 enclosed by cabinet doors 33, 34 that are normally closed during operation.

Referring now particularly to FIGS. 3 and 4, the access side of the beater housing 13 includes a cabinet 36 within which are mounted the pillow block bearings 22, 23 and the pillow block bearing 28. The beaters 15 and 16 and apron sprocket 25 are positioned behind removable access plates 40, 41, and 42. These plates 40, 41 and 42 normally enclose the beaters 15 and 16 on the access side of the beater housing 13, but are removable when inspection, repair or replacement of the beaters 15 and/or 16 is required. This arrangement permits the beaters 15 and 16 to be removed laterally from the access side of the beater housing 13 by disassembly from the pillow block bearings 20, 21, 22 and 23. This is in contrast to the prior art Fiber Controls apparatus referenced above, that required removal of the beaters from the front, downstream end of the beater housing. To accomplish this on the Fiber Controls the flat apron, related components and any machines blocking access must be first removed to gain access to the beaters.

The cabinet 36 is enclosed by doors 44, 45. A safety interlock switch and motor speed sensors prevent the doors from being opened with the Bale opener is operating, i.e., when the beaters 15, 16 are rotating.

In an alternative embodiment a third adjustable beater roll, not shown, may be mounted above the beater 16, either in the same cabinet, enlarged to accommodate it, or in a separate cabinet mounted on top of the beater housing 13. This provides additional flexibility and greater adjustment to provide more precise fiber opening.

A bale opening apparatus is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A bale opening apparatus, comprising:
(a) an inclined conveyor for supporting and feeding a longitudinally-extending array of bales;
(b) a beater assembly positioned at a downstream end of the conveyor for receiving the downstream end of a downstream-most bale being moved by the conveyor, the beater assembly including:
(i) a plurality of beaters laterally mounted on respective shafts across a width of the conveyor for plucking fibers from the bale being fed by the conveyor;
(ii) a beater enclosure within which the beaters are enclosed;
(iii) a drive enclosure positioned laterally to a drive side of the beater enclosure, the drive enclosure including motor assemblies for driving the beaters by rotation of the respective shafts; and
(iv) an access enclosure positioned laterally to an access side of the beater enclosure for allowing access to the beaters for removal and replacement of the beaters laterally from the access side of the beater enclosure.

2. A bale opening apparatus according to claim 1, wherein the beater assembly includes bearing blocks within which the shafts are mounted for rotation.

3. A bale opening apparatus according to claim 1, wherein the access enclosure includes at least one access plate for covering the beaters during operation and removable for gaining access to the beaters.

4. A bale opening apparatus according to claim 1, wherein the access enclosure includes a plurality of access plates for covering respective ones of the beaters during operation and selectively removable for gaining access to respective ones of the beaters.

5. A bale opening apparatus according to claim 1, wherein the access enclosure includes a plurality of access plates for covering respective ones of the beaters during operation and selectively removable for gaining access to respective ones of the beaters and further wherein the beater assembly further includes an apron roll and an apron roll access plate for covering the apron roll during operation and selectively removable for gaining access to the apron roll.

6. A bale opening apparatus according to claim 1, wherein the drive enclosure includes a protective cover for enclosing the drive enclosure and an interlock safety switch for preventing the removal of the protective cover during operation of the beaters.

7. A bale opening apparatus according to claim 1, wherein each beater is provided with an individual motor assembly.

8. A bale opening apparatus according to claim 7, wherein each motor assembly is mounted in the drive enclosure.

9. A bale opening apparatus according to claim 1, wherein each of the beaters is dynamically balanced.
